(19) United States
(12) Patent Application Publication
(10) Pub. No.: US 2025/0010337 A1
(43) Pub. Date: Jan. 9, 2025

(54) METHOD AND SYSTEM FOR LOCATING AND HANDLING AN IDENTIFIER FASTENED TO AN ITEM

(71) Applicant: SIEMENS LOGISTICS GMBH, Nürnberg (DE)

(72) Inventors: Andreas Klossek, Stein-Deutenbach (DE); Bengt Mueck, Nürnberg (DE)

(21) Appl. No.: 18/709,581

(22) PCT Filed: Nov. 22, 2022
(86) PCT No.: PCT/EP2022/082823

§ 371 Date: May 13, 2024

(30) Foreign Application Priority Data
Nov. 30, 2021 (EP) 21211203.1

(51) Int. Cl. B07C 3/10; B25J 9/16; B65G 47/24

(52) U.S. Cl. CPC B07C 3/10; B25J 9/163; B65G 47/24; B65G 2201/0264

(57) ABSTRACT

The automated reading of luggage labels in airport baggage handling systems often fails since luggage labels, on which the luggage can be assigned sorting information, cannot be located and/or cannot be read since they are crumpled/creased/partially hidden. Removing and manually processing unreadable luggage items at a manual coding station requires removal conveyor sections, secure access routes and workstations. To increase the proportion of unreadable luggage items, a method and a system locate and handle a luggage label fastened to an item of luggage and which assigns sorting information to the item. If the identifier is not successfully located by a reader, the item is mechanically handled by a handling device. If the identifier is successfully located but the identifier is not successfully read, the identifier is mechanically handled by the handling device independently of the movement of the item. The item is then processed in accordance with its sorting information.

The present invention relates to the technical field of systems for reading out an identifier that is fastened to an item and has a machine-readable identity, in particular a baggage tag that is attached to a piece of baggage, wherein these systems are frequently used in conveying and sorting systems such as airport baggage conveyor systems.

Pieces of flight baggage are processed automatically using baggage conveyor systems. For identification purposes, the pieces of baggage are marked with baggage tags (identifiers), which consist of a largely two-dimensional flexible strip of material that is printed with information and usually wrapped around a handle on the piece of baggage and glued together at the ends. In addition, small stickers with identification features are usually attached to the piece of baggage. Reading facilities are used to read out the baggage tag. Reading this tag can go wrong for various reasons. If there are multiple valid tags/stickers on a piece of baggage, the correct information cannot be determined. If two pieces of baggage follow each other so closely in the system that they are identified as one piece of baggage by the system and therefore also by the reading facility, the reader recognizes two tags. Since the tag is flexible, it can crumple up during transport or wrap itself around parts of the handle. Individual pieces of baggage (for example rucksacks) that are transported in a help tray can rest on the tag so that it cannot be read. This can also be the case for pieces of baggage that are transported without help trays. A piece of baggage separates from its help tray, which is then recognized by the system as a piece of baggage. The tag may be lost or illegible. If a readout reader is requested, a tag cannot be located.

Whenever a piece of baggage cannot be read at a reading facility, it is moved from the system to a manual workstation (coding station) in order to enable it to be read out successfully. For this purpose, in addition to the coding station, the systems are equipped with outfeeders, waiting positions, processing stations and infeeders. If two pieces of baggage are present, they are separated and scanned manually one after the other and sent to the next process according to the sorting information of the piece of baggage. If the tag is crumpled and/or concealed, it is unfolded manually or drawn out, then scanned and the piece of baggage is then fed into the system again. If there are multiple tags that can be read out (especially smaller stickers), the person decides manually in favor of the valid one. If there is no tag or only one tag that cannot be read, the piece of baggage must be removed from the system. Invalid or poorly legible stickers/tags can be removed at the coding station and new tags are printed and attached. While the successful readout rate in the case of baggage coming directly from check-in is very high, it is much lower for transit baggage.

Manual coding stations must be manned at all times during the operation of the system, even in the case of low capacity utilization, with corresponding human effort. By skillfully positioning the coding stations, one person can operate two stations in cases of low capacity utilization. In any case, a permanent workstation must be built for people. The requirements for this are considerably higher than for maintenance access (ventilation, sound insulation, work paths, escape routes, etc.). In addition to the normal conveyor line, an outfeeder, waiting positions, the workstation and an infeeder are required.

The object of the present invention is therefore to improve the readout rate of identifiers for items without the disadvantages of the prior art. This object is achieved by the solutions described in the independent claims.

The solution according to the invention relates to a method for locating and manipulating an identifier that is fastened to an item and has a unique machine-readable identity, in particular a baggage tag that is fastened to a piece of baggage and assigns sorting information to the item, with the following method steps:
a) Transport the item to a reading apparatus.
b) The reading apparatus attempts to locate and read out the identifier of the item.
c) If the identifier is not located successfully, mechanical manipulation, in particular moving, of the item using a manipulation apparatus and/or by other means and renewed performance of the method from method step b).
d) If the identifier is located successfully and the identifier is not read out successfully, mechanical manipulation, in particular unfolding and/or drawing out and/or turning over, of the identifier using the manipulation apparatus independently of any movement of the item as a whole and renewed performance of the method from method step b).
e) If the identifier is successfully located and read out, further handling of the item according to the sorting information determined by the readout identifier.

The apparatus according to the invention relates to a system for locating and manipulating an identifier that is fastened to an item and has a unique machine-readable identity, in particular a baggage tag that is fastened to a piece of baggage and assigns sorting information to the item, comprising a reading apparatus and a manipulation apparatus. The reading apparatus is designed so as to locate and read out the identifier of the item. The manipulation apparatus is designed so as to mechanically manipulate the identifier as a whole, in particular to unfold and/or rotate and/or draw it out, independently of any movement of the item, in order to enable it to be read out successfully.

Advantageous embodiments of the invention are disclosed in the subordinate claims.

Manipulation is any influencing of the position, location and/or shape of the identifier, for example by gripping, drawing out, rotating, unfolding, uncrumpling or similar. When the item is manipulated, it is moved together with the identifier. Manipulation of the identifier, on the other hand, has essentially no influence on the rest of the item and is therefore independent of any movement or location and orientation of the item. The term identifier covers any marking that has a unique machine-readable identity. In the airport sector, these are nowadays flexible baggage stickers, but the invention is not limited to baggage stickers or pieces of baggage as items, but can also be used for a multiplicity of other items, for example postal items and general logistics items. One way of locating and identifying the identifier of the item, which is only listed as an example, is by recording one or more images of the item and using these images to locate and read the identifier.

The solution according to the invention can be further improved by various embodiments, each of which is advantageous in its own right and, unless otherwise stated, can be combined with one another as desired. These embodiments and the advantages associated with them are discussed below.

According to one embodiment, the manipulation apparatus can be moved toward the identifier, wherein the manipulation apparatus unfolds and/or draws out the identifier by drawing it in and/or in some other way. Both an unfolding process and a drawing out process can therefore be performed either by drawing in or in another way (in another manner). The drawing in can, for example, take place in the manner of a banknote-accepting machine, or with a blower that sucks in or draws in the identifier in order to flatten/uncrumple it. For this purpose, the manipulation apparatus can comprise a suction apparatus, which can be designed like a vacuum cleaner, in order to draw in the identifier. According to one embodiment, the identifier is drawn in using this suction apparatus that is comprised by the manipulation apparatus.

According to one embodiment, the manipulation apparatus, naturally together with any detection apparatus, if it does not have the manipulation area of the manipulation apparatus in its field of vision, and/or the reading apparatus can be moved along a section of the conveyor line of the item while the method is being performed. This can be achieved, for example, in that the manipulation apparatus or the reading apparatus are designed so as to move on guide rails or on their own transport paths at the edge or next to the conveyor line. In this way, the method can be performed without the need for an outfeeder, which requires outfeed paths and space for a coding station. These are only required if the identifier cannot be read successfully, but they only need to be dimensioned for a smaller number of items.

According to one embodiment, the manipulation apparatus can manipulate the identifier and/or the item by gripping movements. For this purpose, the manipulation apparatus can be designed for gripping, in particular in that the manipulation apparatus has at least two robotic fingers on one or two robotic arms or robotic hands. The manipulation apparatus is thus designed for gripping the identifier and/or the item.

According to one embodiment, a detection apparatus can detect a section of the manipulation apparatus that is manipulating the identifier and/or the item, in particular in that the detection apparatus follows a movement of the manipulation apparatus. The detection apparatus can thus be used to monitor all attempts to manipulate the identifier and/or the item.

According to one embodiment, the system can comprise a remote control apparatus for wireless remote control of the manipulation apparatus. The remote control apparatus enables wireless remote control of the manipulation by the manipulation apparatus. The remote control apparatus can be designed as a joystick, as a manually movable twin of the manipulation apparatus or in another manner.

According to one embodiment, the method with a self-learning functionality, in particular an iterative self-learning functionality, can determine the control of the manipulation apparatus in order to improve the speed and success rate of successfully locating and reading out the identifier. The exact design of the self-learning functionality can be selected according to standard methods, reinforcement learning is to be mentioned here, for example.

According to one embodiment, the manipulation apparatus or another apparatus comprised by the system can be designed so as to mechanically manipulate the item, in particular to move it, especially to rotate it, in order to locate the identifier and thus make it readable for the reading apparatus. This can also be performed by another apparatus comprised by the system, especially if the manipulation apparatus is not stable enough for mechanical manipulation of the manipulation apparatus.

The method has, as far as transferable, the same advantages which are listed with regard to the method presented. The description of advantageous embodiments of the invention given so far includes numerous features, some of which are combined in the individual sub-claims to form groups. However, these features can also expediently be considered individually and combined to form expedient further combinations. In particular, these features can be combined individually and in any suitable combination with the method according to the invention, the functional unit according to the invention and the sorting system according to the invention. Thus, method features can also be regarded as properties of the corresponding apparatus unit formulated objectively and conversely.

Embodiments of the invention are explained in more detail below by way of example with reference to the figures. In the drawings:

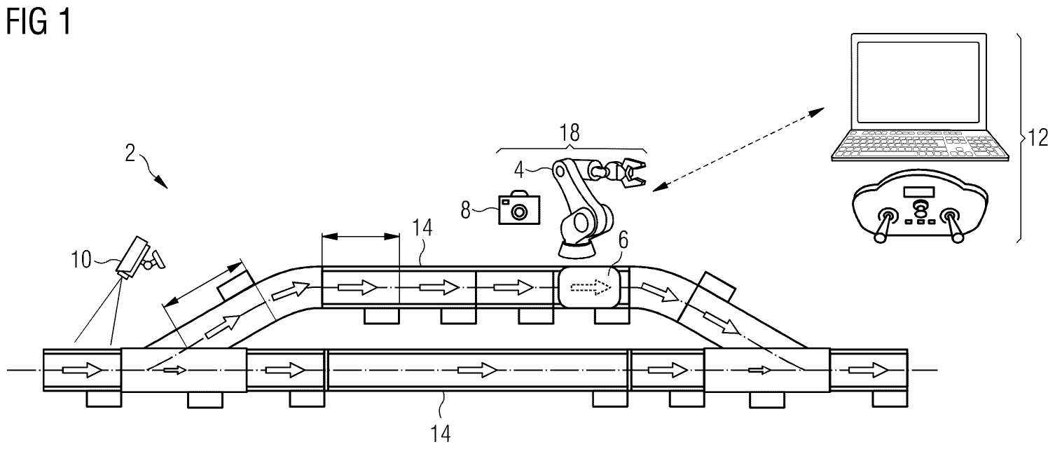

FIG. 1 shows a stationary coding station in a baggage conveyor system;

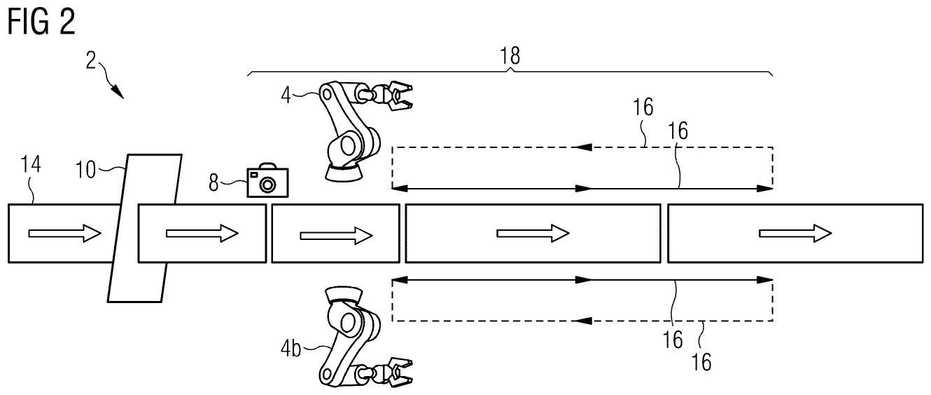

FIG. 2 shows a coding station with two manipulation apparatuses.

In the figures, the invention is described for a piece of baggage as an item and a baggage tag as an identifier, but the invention is also applicable to a multiplicity of other types of items and identifiers.

FIG. 1 shows a robot 4 acting as a manipulation apparatus 4 at a coding station 18 according to one embodiment of the invention. The pieces of baggage are transported along the conveyor line 14 and detected by the reading apparatus 10 at the branch that leads to the coding station 18. At the reading apparatus 10 (typically but not conclusively: a reading gate or an array of cameras), an attempt is made to find and read out the baggage tag of the piece of baggage 6. If the baggage tag is successfully located and successfully read out, the piece of baggage 6 is transported further along the main conveyor line and handled according to its assigned sorting information. If the baggage tag is not successfully located and/or not successfully read out, the piece of baggage 6 is transported on a further conveyor line 14′ to the coding station 18. At the coding station 18, an attempt is first made to localize the baggage tag with the aid of a detection apparatus 8 (camera, array of cameras or similar). If this is not successful, the piece of baggage 6 is repositioned (rotated, raised, etc.) and then a new localization attempt is made with the aid of the detection apparatus 8.

The detection apparatus 8 is a position to perform a classification: if the baggage tag is not located (unsuccessful localization), if it was not read successfully and for what reasons (unreadable, at least partially concealed, crumpled, etc.) or if two or more baggage tags were localized with only one piece of baggage 6 detected (which baggage tag is valid, are two pieces of baggage 6, 6′ too close together and must be read separately, etc.).

If localization is successful, a readout attempt is started. Repositioning is performed using the manipulation apparatus 4 or by other means, for example the conveyor line 14′ can also cause the piece of baggage 6 to rotate, for example by rotating a section of the conveyor line 14′ itself. If the readout attempt was not successful, the baggage tag is manipulated using the manipulation apparatus 4 (robot 4 or similar) independently of any movement of the piece of baggage 6 as a whole in order to enable it to be read out. Typical manipulations include gripping and then drawing out a baggage tag that is only partially visible (for example because it is concealed by a suitcase handle or similar), uncrumpling/smoothing an unreadable baggage tag, rotating or turning over, etc., When the piece of baggage 6 is manipulated as a whole, the baggage tag is also moved simultaneously and thus manipulated, since the baggage tag is attached to the larger and heavier piece of baggage 6. However, manipulation of the baggage tag does not require the piece of baggage to be manipulated/simultaneously moved; its position is essentially not influenced by the manipulation of the baggage tag. Consequently, the baggage tag is manipulated independently of any movement of the piece of baggage 6 as a whole.

If two or more baggage tags are detected, the system checks which of these baggage tags is valid. If necessary, this may also involve two pieces of baggage 6, 6′ that follow very close together and are separated by the conveyor line 14′ (different speeds) or manipulation apparatus 4 and then handled separately.

According to one embodiment, the manipulation apparatus 4 has gripping apparatuses for manipulating the piece of baggage 6 and/or for manipulating the baggage tag independently of any manipulation/movement of the piece of baggage 6 itself; at least two robotic fingers on one or two robotic arms or hands are particularly suitable for this purpose. According to a further embodiment, the manipulation apparatus 4 has a drawing-in apparatus and/or a blower in order to smoothen/uncrumple/unfold the baggage tag by drawing it in and thus to make it readable. According to one embodiment, this drawing-in apparatus for drawing in the baggage tag is designed as a suction apparatus; according to a further embodiment, it is designed in the manner of a cash machine that draws in a banknote.

In order to observe and control the manipulation, according to one embodiment the detection apparatus 8 can always follow the movements of the robot 4, for example by being mounted directly on the robot 4 itself or by being arranged above the robot 4, i.e. in a bird's eye view-stationary or moving simultaneously.

Once the valid baggage tag has been successfully read out, the piece of baggage 6 is returned from the further conveyor line 14′ to the main conveyor line 14 and then handled according to the associated sorting information.

According to one embodiment, the manipulation movements of the robot 4 are controlled fully automatically. Preferably, the method uses a-preferably, but not necessarily iterative-self-learning functionality in order to continuously improve the success rate and speed of locating, manipulating and reading out as the number of pieces of baggage 6 that are already manipulated by the robot 4 increases.

According to one embodiment, when required (no successful locating and/or reading out of the baggage tag), remote-controlled intervention is used in order to enable successful reading out of the baggage tag in cases where the automated process fails, without a human having to be physically present in the case of the piece of baggage 6. For this purpose, the system comprises a remote control apparatus 12, which can be designed in different ways, for example as a simple operating functionality on the computer, in the manner of a game console or as a manually movable twin, possibly glove-like, of the gripping tools of the robot 4. In this case, the operator can control the robots 4 from more than one coding station 18.

While the embodiment shown in FIG. 1 shows a stationary coding station 18, the embodiment shown in FIG. 2 shows a moving coding station 18 with manipulation apparatuses 4 moving simultaneously along the transport path 14 of the piece of baggage and which is designed in the same way as the robot 4 shown in FIG. 1 or in another manner. Firstly, the piece of baggage 4 travels through the reading apparatus 10. If the latter is unable to locate the baggage tag or is able to locate it but is unable to read it, the manipulation apparatus 4 will manipulate the piece of baggage (rotate it, fold away any suitcase handles or similar that are potentially concealing the baggage tag) in order to locate the baggage tag, followed by a readout attempt.

The readout attempt is performed by a separate detection apparatus 8 or by a detection apparatus 8 that is comprised by the manipulation apparatus 4, wherein the readout attempt can of course also be performed with the aid of an image of the piece of baggage 6. If the readout attempt was successful, the piece of baggage 6 is handled according to the sorting information, otherwise the baggage tag is manipulated as described above during the further transport of the piece of baggage 6 on the conveyor line 14. Thus, although the piece of baggage is moved during the manipulation of the baggage tag, the manipulation of the baggage tag does not influence the movement of the piece of baggage 6 itself. Only if a successful readout cannot be performed is the piece of baggage 6 fed out in the further method and handled manually. The robot 4 can either move back and forth (continuous travel path 16) or circularly (continuous and dashed path 16), wherein the latter has the advantage that multiple robots 4 can be used simultaneously. In the case of a low capacity utilization, it is of course possible to perform the manipulation while the conveyor line 14 is stopped.

If there is sufficient space along the conveyor line 14, it is possible, according to one embodiment, to arrange multiple robots 4, if necessary in each case together with a detection apparatus 8, on both sides of the conveyor line 14 as shown in FIG. 2 in order to increase the capacity.

According to one embodiment, it is naturally also possible for the manipulation apparatus 4 to have two or more gripping apparatuses and the piece of baggage 6 is simply raised during the process of locating and/or manipulating the baggage tag with the aim of successfully reading out the baggage tag and after completion is set back down again on the conveyor line 14. In this case, the manipulation apparatus 4 does not have to be moved along the conveyor line 14.

In lieu of a person, the steps required to locate and read out the identifier are performed by a machine 4. The piece of baggage 6 at the coding station 18 is detected by a camera 8. The event is classified (for example piece of baggage 6 lying on tag in tray or two pieces of baggage 6 travelling together). Combinations of cases are possible.

In detail, the cases are handled according to their own embodiments as follows:
a) Double pieces of baggage 6 are separated by conveyors 14 at different speeds or by the manipulation apparatus 4. During this manipulation of the pieces of baggage 6, their baggage tags are also moved simultaneously.
b) Crumpled baggage tags are uncrumpled or unfolded by a blower (and/or suction facility) as a tool of the manipulation apparatus 4. If this is not sufficient, a small gripper is used on a robotic tip of the manipulation apparatus 4 and can unfold the baggage tag and/or simply draw it out, for example, if it is completely or partially concealed by the piece of baggage 6 itself. The method steps b) are manipulations of the baggage tag independently of any movement of the item 6 as a whole.
c) If the baggage tag is concealed by the piece of baggage 6 for other reasons, the piece of baggage 6 is rotated using a gripper as a robotic hand until the baggage tag is visible; the piece of baggage 6 and the baggage tag are simultaneously manipulated/moved. This also applies in the case of a piece of baggage 6 in a help container 6.
d) If a baggage tag is not present, the piece of baggage 6 is moved out of the system. If this is classified, this can be done without the intervention of a person. Empty help containers 6 are also recognized and handled accordingly.
e) If multiple tags are present, a camera system 8, 10 can distinguish smaller stubs from large baggage tags and prioritize them accordingly.
f) If a new baggage tag needs to be attached, a sticker can be applied to the piece of baggage 6 using known methods.
g) If invalid baggage tags/stickers have to be removed, they can be covered by stickers.

The cases can occur in a combined sequence. According to a further embodiment, it is proposed to perform the method in the order a), d), e), b), c), f).

In one embodiment, the robot 4 is to be operated by remote control by a person. For the case of low capacity utilization, this person is to be able to control multiple coding stations 18.

This control can also take place outside the airport. The work of multiple airports can be combined.

According to one embodiment, the process is completely automated using suitable software. The work of the person remotely controlling the manipulation device 4 is replaced by control software.

In a further embodiment, the pieces of baggage 6 are not fed out. The robot 4 travels parallel to the main line 14. This can be done by a 7-axis robot or with a suitable guide (for example overhead crane). The robot 4 waits upstream. If a piece of baggage 6 that requires coding passes by, the robot 4 moves simultaneously with it and performs the steps described. At the end of the coding process, the robot 4 returns to the waiting position. If a further piece of baggage 6 arrives at the waiting position during the coding task, the line is stopped until the robot 4 can pick up this piece of baggage. The performance can be increased by using two (for example one from each side) or more robots 4. Also, this case can both be remote-controlled or also fully automated.

The number of people with a workstation in the system 2 is reduced. Elaborate work and escape routes do not have to be built. No enclosures are required for air conditioning and noise protection. In phases of low capacity utilization, one person can operate more coding stations 18 since they do not need to be physically present. In the automated version, it is even possible to largely dispense with personnel performing simple tasks.

If a robot 4 is travelling simultaneously (FIG. 2), there is no need for the outfeed, parallel conveyor technology and the infeed (FIG. 1). Fewer conveyors 14 are required and the system 2 is therefore more compact.

### LIST OF REFERENCE CHARACTERS

2 Conveyor system
4 Manipulation apparatus, robot
6 Item, piece of baggage, conveyor tray with an item
8 Detection apparatus
10 Reading apparatus
12 Remote control apparatus
14 Transport path, conveyor line
16 Robot travel path
18 Coding station

1-15. (canceled)

16. A method for locating and manipulating an identifier that is fastened to an item and has a unique machine-readable identity, which comprises the following method steps of:
a) transporting the item to a reading apparatus;
b) locating and reading out the identifier of the item using the reading apparatus;
c) mechanically manipulating the item using a manipulation apparatus and/or other means and renewed performance of the method step b) if the identifier is not located successfully;
d) mechanically manipulating the identifier using the manipulation apparatus independently of moving the item as a whole and renewed performance of the method from method step b) if the identifier is located successfully and the identifier is not read out successfully;
e) further handling of the item according to sorting information determined by a readout identifier.

17. The method according to claim 16, which further comprises moving the manipulation apparatus toward the identifier, wherein the manipulation apparatus unfolds or draws out the identifier by drawing it in or in some other way.

18. The method according to claim 17, which further comprises drawing in the identifier using a suction apparatus that is a part of the manipulation apparatus.

19. The method according to claim 16, which further comprises moving the manipulation apparatus and/or the reading apparatus along a section of a conveyor line for the item while the method is being performed.

20. The method according to claim 16, wherein the manipulation apparatus manipulates the identifier and/or the item by gripping movements.

21. The method according to claim 16, which further comprises detecting, via a detection apparatus, a section of the manipulation apparatus that is manipulating the identifier and/or the item.

22. The method according to claim 21, wherein the detection apparatus follows a movement of the manipulation apparatus.

23. The method according to claim 16, wherein the method with a self-learning functionality determines a control of the manipulation apparatus in order to improve a speed and success rate of successfully locating and reading out the identifier.

24. The method according to claim 23, wherein the self-learning functionality is an iterative self-learning functionality.

25. The method according to claim 16, wherein:
the identifier is a baggage tag fastened to a piece of baggage and assigns the sorting information to the item;
in the step c), the mechanically manipulating of the item includes moving of the item; and
in the step d) the mechanically manipulating of the identifier includes unfolding, and/or drawing out, and/or turning over of the identifier.

26. A system for locating and manipulating an identifier that is fastened to an item and has a unique machine-readable identity, the system comprising:
a reading apparatus configured for locating and reading out the identifier of the item; and
a manipulation apparatus configured to mechanically manipulate the identifier as a whole, independently of a movement of the item, in order to enable the identifier to be read out successfully.

27. The system according to claim 26, wherein said manipulation apparatus is configured so as to mechanically manipulate the item in order to locate the identifier.

28. The system according to claim 26, wherein said manipulation apparatus is configured so as to be moved toward the identifier and draw in and/or in some other way unfold and/or draw out the identifier.

29. The system according to claim 28, wherein said manipulation apparatus has a suction apparatus in order to draw in the identifier.

30. The system according to claim 26, wherein said manipulation apparatus and/or said reading apparatus are configured so as to be moved along a section of a conveyor line for the item.

31. The system according to claim 26, wherein said manipulation apparatus is equipped for gripping.

32. The system according to claim 26, further comprising a detection apparatus configured so as to detect a section of said manipulation apparatus that is manipulating the identifier and/or the item.

33. The system according to claim 26, further comprising a remote control apparatus for wireless remote control of said manipulation apparatus.

34. The system according to claim 31, wherein said manipulation apparatus has at least two robotic fingers on one or two robotic arms.

35. The system according to claim 32, wherein said detection apparatus is configured so as to follow a movement of said manipulation apparatus.
